(19) United States
(12) Patent Application Publication
(10) Pub. No.: US 2004/0072084 A1
(43) Pub. Date: Apr. 15, 2004

(54) Process on the basis of laser printing for making color filter

(75) Inventors: Wen-chin Lo, jubei City (TW); Dao-yang Huang, Hsinchu (TW); Fu-sheng Tseng, Yungkang City (TW)

Correspondence Address: KLARQUIST SPARKMAN, LLP, 121 SW SALMON STREET, SUITE 1600, PORTLAND, OR, 97204, US

(73) Assignee: Cando Corporation

(21) Appl. No.: 10/269,208

(22) Filed: Oct. 10, 2002

(51) Int. Cl. G02B 5/20

(52) U.S. Cl. 430/7

(57) ABSTRACT

The present invention generally relates to a scheme for making color filters on the basis of laser printing, and particularly to a scheme exploiting digital systems (or logic processor) and laser printer to make color filters in a simple, economical, and swift way, and being capable of dynamically adapting to various demanded specifications. The scheme for making color filters according to the present invention mainly comprises the steps: defining a dot matrix according to the demanded specifications; converting the dot matrix into an image signal; and executing a laser printing process to print, according to the image signal, an image of the dot matrix on a transparent plate.

### FIELD OF THE INVENTION

The present invention generally relates to a process for making color filters on the basis of laser printing, and particularly to a process applying digital systems or logic processor to the production of color filters.

### BACKGROUND OF THE INVENTION

For conventional processes of making color filters, the cost of requisite equipment and components, as well as the cost of operation (such as labor, material, and consumption/loss) can be hardly reduced. Furthermore, the conventional processes of making color filters are always subject to significant defects resulting from the particles inherent therein, and leave scarce room for shortening its production time period, time for switching between product lines, and time for transition from off to regular full load operation, leading to the fact that the quality and price of color filters constitute a bottle-neck of generalizing the application of related products (Liquid Crystal Display, for example).

A typical conventional process using pigment-dispersion scheme to make color filters is described as follows with reference to FIG. 1. As shown in FIG. 1, the typical conventional process comprises the steps of: cleaning (represented by 61 in FIG. 1) glass substrate 81; deposing (represented by 62 in FIG. 1) film 82 such as Cr/CrOx on a surface of glass substrate 81 to form (represented by 63 in FIG. 1) black matrix layer 83; forming (represented by 64 in FIG. 1) preset layer 84 requisite for disposing photo-resistant layer, exposing (represented by 65 in FIG. 1) by means of mask 86 and light beam 85; developing (represented by 66 in FIG. 1); successively forming (represented by 67, 68, and 69 in FIG. 1) red photo-resistant layer 87, green photo-resistant layer 88, and blue photo-resistant layer 89; forming (represented by 70 in FIG. 1) flat cover layer 90; and then deposing (represented by 71 in FIG. 1) ITO layer 91 if required. It can thus be seen that a typical conventional process of making color filters includes a variety of petty steps, and has to critically rely on skilled technicians, cautious operation, accuracy of production apparatus, quality of components/material, and production environment, resulting in extreme difficulty in lowering cost, also resulting in the fact it has to suffer from a variety of factors which are critical to product quality while being hardly controllable. Furthermore, its production time period, time for switching between product lines, and time for transition from off to regular full load operation can hardly be shortened.

To improve the conventional processes of making color filters, although some schemes on the basis of inkjet printing have been used for making color filters, the inkjet printing based processes are still subject to bottle-necks in solving reliability problems of ink-jet head, and in lowering cost (particularly the bottle-neck resulting from difficulty in lowering operational cost and component/material cost) as well as shortening production time period to meet a variety of market demand. Consequently not only are the related industries currently looking forward to solutions to these problems, but also the market oriented supply-demand coordination in the future will force suppliers to significantly curtail production time period, particularly when the flexibility, mobility, and variety of supplying color filters become important as a result of related applications getting varied and popularized. It can thus be understood that the inkjet printing based processes will still unable to meet market oriented supply-demand coordination, and the competitive capability of supplying color filters must be further promoted. The present invention is therefore developed on one hand to overcome the bottle-necks in lowering cost and shortening production time period reduction, and on the other hand to meet the trend of supply-demand coordination in the market related to color filter applications.

### SUMMARY OF THE INVENTION

A first object of the present invention is to lower the cost of making color filters.

A second object of the present invention is to shorten the production time period of making color filters.

A third object of the present invention is to shorten the time for switching between product lines of making color filters of various specifications.

A fourth object of the present invention is to shorten the time for transition from off to regular full load operation in the processes of making color filters of various specifications.

A fifth object of the present invention is to prepare for the trend of supply-demand coordination in the market related to color filter applications.

A sixth object of the present invention is to release color filter production processes from its critical reliance on skilled workers, cautious operation, accuracy of production apparatus, quality of components/material, and production environment.

A typical aspect of the present invention is a process for making a color filter on the basis of a transparent plate according to demanded specifications, wherein the transparent plate includes a surface. The process comprises the steps of:

defining a dot matrix according to the demanded specifications in such a way that the area between any adjacent dots of the dot matrix is in black color, and any adjacent dots of the dot matrix are respectively in different primary colors such as red, green, and blue colors;

converting the dot matrix into an image signal; and

executing a laser printing process to print, according to the image signal, an image of the dot matrix on the transparent plate, with light absorbing material and photo resistant material in primary colors as pigments.

In the above process, a laser printer may be used to execute the laser printing process according to the image signal inputted thereto. The laser printer may include a toner container containing light absorbing material, and include another toner containers respectively containing photo resistant material of different types each in a different one of primary colors. For example, the laser printer may include a first toner container containing light absorbing material, a second toner container containing photo resistant material in red color, a third toner container containing photo resistant material in green color, and a fourth toner container containing photo resistant material in blue color.

In the above process, the dot matrix may be defined by configuring a dot matrix pattern in a display via an input means, the dot matrix pattern convertible into an image signal representing the dot matrix, the image signal may be sent to the laser printer or be stored in a memory, or be sent to the laser printer and be stored in a memory at the same time. The dot matrix may also be defined by scanning an image of a sample of the color filter and providing, according to the scanned image, an image signal representing the dot matrix.

It can be seen now the process for making color filters according to the present invention features: application of computer or logic processor to dynamically adapt production to various demanded specifications; and application of laser printing to make color filters simply, economically, and swiftly, leading to achieving the objects of the present invention.

The present invention may best be understood through the following description with reference to the accompanying drawings, in which:

### BRIEF DESCRIPTION OF THE DRAWINGS

FIG. 1 is a diagram for describing a typical conventional process of making color filters according to a pigment-distribution scheme.

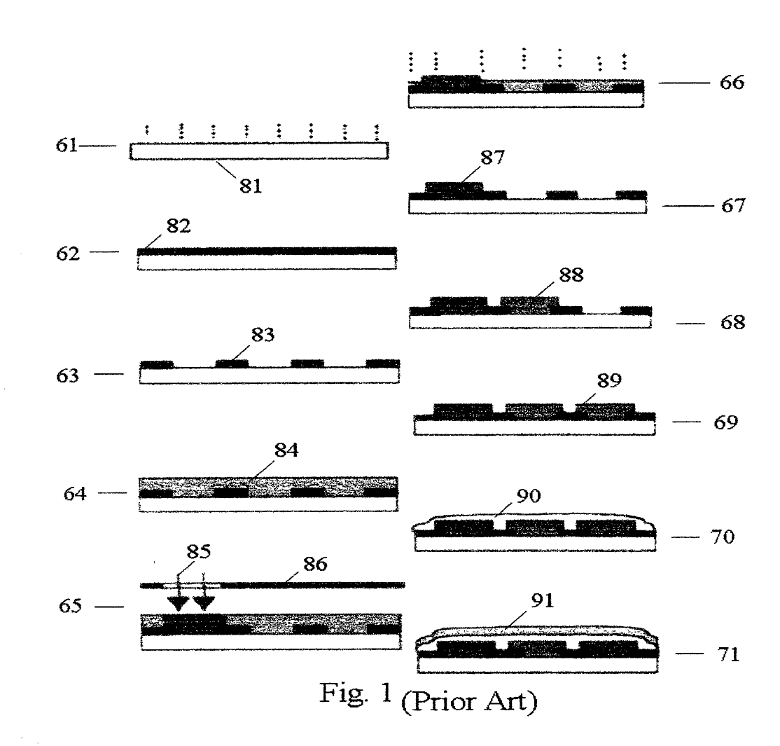

FIG. 2 is a block diagram showing one preferred embodiment of a process of making color filters according to the present invention.

FIG. 3 shows an example of a dot matrix in a process of making color filters according to the present invention.

FIGS. 4A-4E are schematic diagrams for describing a laser printing process according to the present invention.

### DETAILED DESCRIPTION OF THE PREFERRED EMBODIMENTS

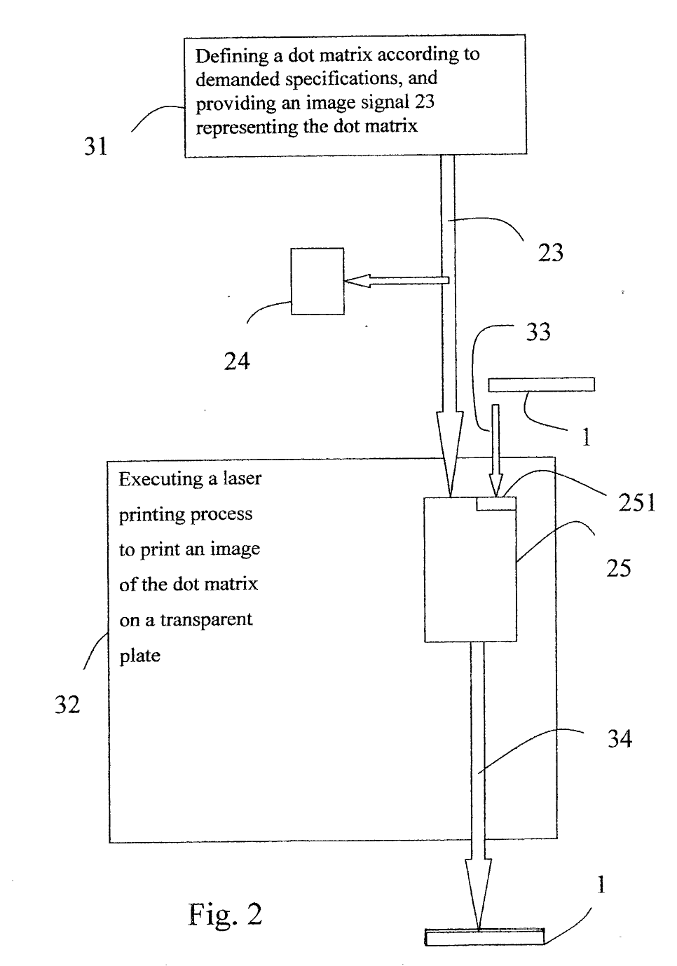

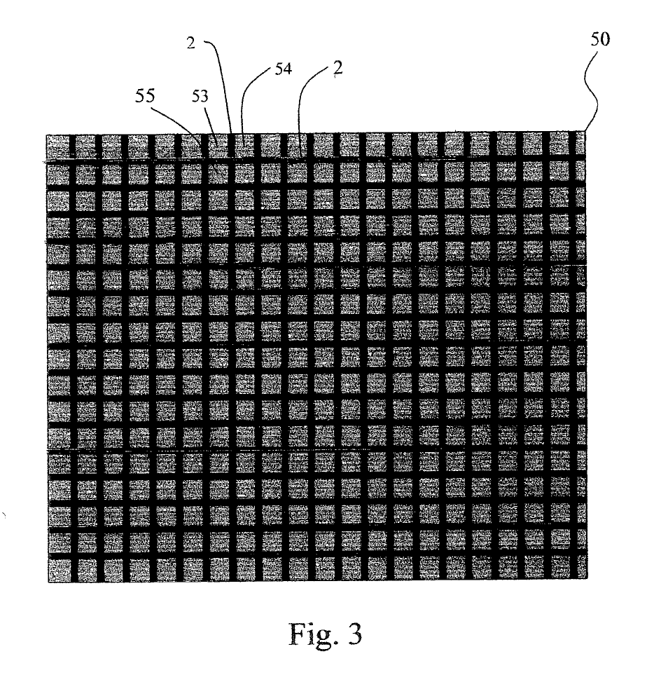

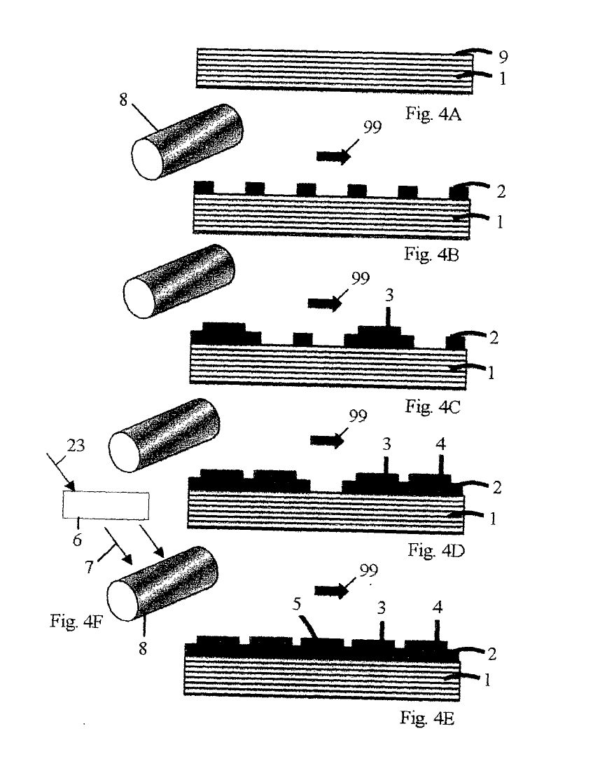

A typical process for making a color filter according to the present invention is described hereinafter with reference to FIG. 2 (block diagram), FIG. 3 (an example of dot matrix), and FIG. 4A. In the process, a transparent plate 1 as shown in FIG. 4A is used as the main material for making a color filter according to demanded specifications, wherein the transparent plate 1 includes a surface 9 (FIG. 4A). The process comprises: a step (denoted by numeral reference 31 in FIG. 2) of defining a dot matrix, and a step (denoted by numeral reference 32 in FIG. 2) of executing a laser printing process.

Step 31 defines a dot matrix (such as the one denoted by 50 shown in FIG. 3) according to the demanded specifications in such a way that the area 2 (in FIG. 3) between any adjacent dots (such as 53 and 54, 53 and 55 in FIG. 3) of the dot matrix 50 is in black color, and any adjacent dots (such as 53 and 54, 53 and 55 in FIG. 3) of the dot matrix 50 are respectively in different primary colors. For example, if dot 53 is in red color, then dots 54 and 55 are respectively in green and blue colors. The dot matrix may be defined by configuring a dot matrix pattern in a display (not shown in figure) via input means (not shown in figure), wherein the dot matrix pattern is represented by a digital signal that may be an image signal 23 or may be converted into the image signal 23, may be stored in a memory 24, or may be transmitted to a laser printer 25, or may be stored in memory 24 and transmitted to laser printer 25 at the same time.

Step 32 of executing a laser printing process prints, according to the image signal 23, an image of the dot matrix 50 on surface 9 of the transparent plate 1 (in FIG. 4A), with light absorbing material and photo resistant material in primary colors used as pigments. An embodiment of step 32 is that a laser printer 25 is used to print an image of dot matrix 50 on surface 9 of the transparent plate 1, wherein laser printer 25 includes a toner container containing light absorbing material, and includes another toner containers respectively containing photo resistant material of different types each in a different one of primary colors. For example, the laser printer 25 may include a first toner container (not shown in figure) containing light absorbing material, a second toner container (not shown in figure) containing photo resistant material in red color, a third toner container (not shown in figure) containing photo resistant material in green color, and a fourth toner container (not shown in figure) containing photo resistant material in blue color.

In the above process according to the present invention, the image signal 23 stored in memory 24 may be transmitted to laser printer 25 at any time for executing the laser printing process (step 32). The image signal 23 stored in memory 24 may even be modified any time to adapt to new demanded specifications of color filters.

The above process according to the present invention may further comprise a step (denoted by arrow 33 in FIG. 2) of providing transparent plate 1 to the input entrance 251 of laser printer 25, wherein the specifications of transparent plate 1 correspond to the shape and size of the dot matrix 50. The above process according to the present invention may also further comprise a step (denoted by arrow 34 in FIG. 2) of outputting transparent plate 1 from laser printer 25 after the image of dot matrix 50 is printed on the surface of transparent plate 1.

In the above process according to the present invention, dot matrix 50 may be defined by scanning an image of a sample of a color filter matching demanded specifications, and providing, according to the scanned image, the image signal 23 representing the dot matrix (or the image of the sample), followed by transmitting image signal 23 to laser printer 25, or storing image signal 23 in memory 24, or transmitting image signal 23 to laser printer 25 and storing image signal 23 in memory 24 at the same time.

In the above process according to the present invention, step 31 of defining dot matrix 50 is not always necessary for providing image signal 23, image signal 23 may be read from memory 24 and then transmitted to laser printer 25. Image signal 23 may also be modified any time via a system (not shown in figure) including input means (such as a keypad) and display means (such as a monitor or LCD), and then transmitted to laser printer 25, or stored in any memory unit (inside or outside printer 25) to be accessed any time later for executing the laser printing process.

The distribution of primary colors over dot matrix 50 is such that the evener it is the better the product will be. For example, the dots 53, 54, and 55 (FIG. 3) are respectively in different primary colors such as red, green, and blue colors, i.e., any adjacent two dots (such as 53 and 54, 53 and 55) are in different primary colors.

An embodiment of the laser printing process according to the present invention is described as follows with reference to FIGS. 4A, 4B, 4C, 4D, and 4E. As shown in FIG. 4E, laser beam generator 6 provides, according to image signal 23, a laser beam 7 (or laser light) to the surface of an object (such as the cylindrical roller 8 in FIG. 4F) which includes photosensitive material and/or electrically inductive material, resulting in forming a latent image (not shown in figure) of the dot matrix 50 on the surface of object 8. An example of the latent image is a latent electrostatic image. Due to an attraction force resulting from the latent image, if the object 8 and/or material containers (not shown in figure) are/is moved in such a way (not shown in figure) that the light absorbing material and photo resistant material are approximate enough to the surface of object 8, the light absorbing material and the photo resistant material in different primary colors are respectively attached to (according to the latent image of the dot matrix 50) their corresponding parts of the surface of object 8. For example, the light absorbing material is attached to the part which corresponds to the area 2 (in FIGS. 3, and 4B-4E) between adjacent dots of dot matrix 50, the photo resistant material 3 in red color is attached to the part which corresponds to red dot 53 (in FIG. 3) of dot matrix 50, the photo resistant material 4 in green color is attached to the part which corresponds to green dot 54 (in FIG. 3) of dot matrix 50, and the photo resistant material 5 in blue color is attached to the part which corresponds to blue dot 55 (in FIG. 3) of dot matrix 50. After the light absorbing material and the photo resistant material in different primary colors are respectively attached to their corresponding parts of the surface of object 8, the object 8 and/or material containers are/is moved away from each other.

After the light absorbing material and the photo resistant material are attached to their corresponding parts of the surface of object 8, and the object 8 and/or material containers are/is moved away from each other, object 8 and/or transparent plate 1 are/is moved in such a way that the surface of object 8 and the surface 9 of the transparent plate are close enough to each other for at least part of the light absorbing material and the photo resistant material to be respectively transferred from the surface of object 8 to the surface 9 of transparent plate 1, thereby an image of dot matrix 50 appears on surface 9 of transparent plate 1 as a result of the attachment of the absorbing material and the photo resistant material (three types in different primary colors) to surface 9 of transparent plate 1. For example, at least part of the light absorbing material and at least part of the photo resistant material of each primary color are respectively transferred from the surface of the object 8 to their corresponding parts of surface 9 of the transparent plate 1, and the transparent plate 1 which has had light absorbing material and the photo resistant material on the surface 9 thereof is then moved away (e.g., in a direction denoted by 99 in FIG. 4E) from object 8, to be a product of color filter.

What is shown in FIG. 4E represents a laser printing process in which the light absorbing material 2 and the photo resistant material 3 (red color), 4 (green color), and 5 (blue color) are all synchronously printed onto surface 9 of transparent plate 1.

Another embodiment of the laser printing process according to the present invention may comprise different steps respectively printing the light absorbing material and the photo resistant material (in each primary color) on the transparent plate, as shown in FIGS. 4B-4D. For example, a step prints light absorbing material 2 on surface 9 of the transparent plate 1 as shown in FIG. 4B, another step prints photo resistant material 3 (in red color) on surface 9 of the transparent plate 1 as shown in FIG. 4C, a further step prints photo resistant material 4 (in green color) on surface 9 of the transparent plate 1 as shown in FIG. 4D, and another further step prints photo resistant material 5 (in blue color) on a surface of a transparent plate which finally appears the same as the transparent plate 1 shown in FIG. 4E. A complete image of dot matrix 50 is thus formed on a surface of a transparent plate which is to be used as a color filter.

The process for making a color filter according to the present invention may further comprise a step of covering the light absorbing material (such as material 2 in FIGS. 4B-4E) and the photo resistant material (such as material 3, 4, and 5 shown in FIGS. 4C-4E) by a protection layer (not shown in figure), following the step of forming a complete image of dot matrix 50 (as shown in FIG. 3). The protection layer may further cover the part of surface 9 which has not been covered by light absorbing material 2 and photo resistant material 3, 4, and 5, after forming a complete image of dot matrix 50 on the surface 9 of transparent plate 1. Depending on demanded specifications, a film of ITO (not shown in figure) may be formed on the protection layer, or directly on light absorbing material 2 and photo resistant material 3, 4, and 5.

The light absorbing material 2 according to the present invention may be in black color with capability of blocking light, or may be material with capability of anti-reflection. The photo resistant material such as those represented by 3, 4, and 5 in FIGS. 4B-4E are material allowing only the light of a specific color to propagate therethrough. For example, the photo resistant material respectively in three primary colors such as red, green, and blue, respectively allow only the light of red, green, and blue colors to propagate therethrough.

The dot matrix 50 according to the above process embodiment may be configured with main reference to the resolution of demanded color filters. The dots of dot matrix 50 according to the present invention are not necessarily located in straight lines, all the dots adjacent to an arbitrary dot are not necessarily symmetrically located relative to the arbitrary dot, the shape and size of all dots are not necessarily consistent, and the dot may be in any shape. What is important is that the more evenly the black color and each of the primary colors are distributed over the dot matrix 50, the more evenly the photo resistant material and the light absorbing material will be printed on transparent plate 1, and the better the product may be.

While the invention has been described in terms of what are presently considered to be the most practical or preferred embodiments, it shall be understood that the invention is not limited to the disclosed embodiment. The spirit and scope of the invention shall cover any modifications or similar arrangements.

What is claimed is:

1. A process for making a color filter on the basis of a transparent plate according to demanded specifications, said transparent plate including a surface, said process comprising the steps of:
defining a dot matrix according to said demanded specifications in such a way that the area between adjacent dots of said dot matrix is in, black color, and adjacent dots of said dot matrix are respectively in primary colors;
converting said dot matrix into an image signal; and
using a laser printer to print, according to said image signal, an image of said dot matrix on the surface of said transparent plate, said laser printer including a toner container containing light absorbing material, and including another toner containers respectively containing photo resistant material of different types each in a different one of primary colors.

2. The process according to claim 1 further comprising a step of providing said transparent plate to said laser printer, the specifications of said transparent plate corresponding to the shape and size of said dot matrix.

3. The process according to claim 1 wherein said dot matrix is defined by configuring a dot matrix pattern in a display via an input means, said dot matrix pattern convertible into an image signal representing said dot matrix.

4. The process according to claim 1 further comprising at least a step selected from among sending said image signal to said laser printer and storing said image signal in a memory.

5. The process according to claim 1 wherein said dot matrix is defined by scanning an image of a sample of said color filter and providing, according to the scanned image, an image signal representing said dot matrix.

6. The process according to claim 1 wherein each of said primary colors is evenly distributed on said dot matrix.

7. A process for making a color filter on the basis of a transparent plate according to demanded specifications, said transparent plate including a surface, said process comprising the steps of:
defining a dot matrix according to said demanded specifications in such a way that the area between adjacent dots of said dot matrix is in black color, and adjacent dots of said dot matrix are in different one of primary colors;
converting said dot matrix into an image signal; and
executing a laser printing process to print, according to said image signal, an image of said dot matrix on said transparent plate, with light absorbing material and photo resistant material in primary colors as pigments.

8. The process according to claim 7 wherein the step of executing the laser printing process comprises the steps of:
using laser light to form, according to said image signal, a latent image of said dot matrix on a surface of an object including photosensitive material and electrically inductive material;
letting said latent image draw said light absorbing material and said photo resistant material respectively to different parts of the surface of said object; and
moving at least one of said object and said transparent plate in such a way that the surface of said object and the surface of said transparent plate are close enough for at least part of said light absorbing material and at least part of said photo resistant material to be respectively transferred from the surface of said object to the surface of said transparent plate.

9. The process according to claim 7 wherein said laser printing process is such that said light absorbing material and said photo resistant material are synchronously printed on the surface of said transparent plate.

10. The process according to claim 7 wherein said laser printing process comprises different steps respectively printing said light absorbing material and said photo resistant material in different colors on said transparent plate.
